(19) United States
(12) Patent Application Publication
(10) Pub. No.: US 2021/0256108 A1
(43) Pub. Date: Aug. 19, 2021

(54) USE OF STEGANOGRAPHY TO AUTHENTICATE PROVIDER OF PACKAGE, DEVICE, OR DEVICE COMPONENT

(71) Applicant: Lenovo (Singapore) Pte. Ltd., Singapore (SG)

(72) Inventors: Robert J. Kapinos, Durham, NC (US); Robert Norton, Raleigh, NC (US); Russell Speight VanBlon, Raleigh, NC (US); Scott Wentao Li, Cary, NC (US)

(21) Appl. No.: 16/793,250

(22) Filed: Feb. 18, 2020

(51) Int. Cl. G06F 21/44

(52) U.S. Cl. CPC G06F 21/44

(57) ABSTRACT

In one aspect, the present application relates to a package or computer-related component that may indicate steganographic data that indicates a provider of the device. The present application also relates to using other electronic devices to identify and authenticate that the package or computer-related component is from the provider.

### FIELD

The present application relates to technically inventive, non-routine solutions that are necessarily rooted in computer technology and that produce concrete technical improvements.

### BACKGROUND

As recognized herein, certain advances have made it easier for sophisticated imposters to provide counterfeit computers that are technologically insufficient to end-users under the pretense of being the legitimate manufacturer of the computer. There are currently no adequate solutions for circumventing the foregoing computer-related, technological problem.

### SUMMARY

Accordingly, in one aspect a package or computer-related component may be established by a device. The device may include a housing, at least one processor coupled to the housing, a display accessible to the at least one processor and coupled to the housing, and storage accessible to the at least one processor coupled to the housing. The housing may indicate steganographic data that indicates a provider of the device. The provider of the device may be a manufacturer of the device.

In some implementations, the housing may indicate the steganographic data on an exterior surface of the housing. For example, the exterior surface of the housing may indicate the steganographic data via a textured surface of the exterior surface, with the textured surface including peaks and/or valleys establishing the steganographic data. Thus, the textured surface may be established by grooves into the exterior surface and/or bumps protruding from the exterior surface. As another example, the exterior surface of the housing may indicate the steganographic data via a doped layer, such as a layer including grains in a particular arrangement that indicates the provider, a layer including magnetic dopant in a particular arrangement that indicates the provider, and/or a layer including dopant in a particular arrangement that indicates the provider by reflecting one or more particular wavelengths of light that are not in the visible light spectrum. As another example, the exterior surface may include a repeating or non-repeating pattern, with the steganographic data indicated by the way in which the repeating pattern repeats or the non-repeating pattern does not repeat, respectively.

Still further, in some implementations the housing may indicate the steganographic data on a substrate underneath an exterior surface of the housing, where at least a portion of the exterior surface may be at least semi-transparent for the steganographic data to be identified through the portion of the exterior surface.

Additionally, in some implementations the housing may indicate the steganographic data via recesses and/or tabs in the housing created by at least one mold used to form at least a portion of the housing.

Furthermore, if desired the steganographic data may indicate a checksum, a digital signature, a digital signature hash, and/or a universally unique identifier (UUID) for the provider.

In another aspect, a method includes using an electronic device to identify concealed data on packaging for a product and/or the product itself. The method also includes using the electronic device to authenticate that the product is from a predefined manufacturer. The electronic device may include a camera used to identify the concealed data.

In some examples, the method may also include receiving the product prior to using the electronic device to identify the concealed data and authenticate that the product is from the predefined manufacturer. In these examples, the method may then include providing the product to an end-user based on identifying the concealed data and authenticating that the product is from the predefined manufacturer.

In still another aspect, an enclosure for at least one component related to a consumer electronics device includes a first portion that indicates latent or obscured data that is related to a manufacturer of the at least one component. The enclosure may be established by packaging for the at least one component, and/or may be established by at least a part of a housing for the at least one component.

The details of present principles, both as to their structure and operation, can best be understood in reference to the accompanying drawings, in which like reference numerals refer to like parts, and in which:

### BRIEF DESCRIPTION OF THE DRAWINGS

FIG. 1 is a block diagram of an example system consistent with present principles;

FIG. 2 is a block diagram of an example network of devices consistent with present principles;

FIGS. 3, 4A-4C, and 5 show an example implementation of a computer housing that has bumps and/or grooves consistent with present principles;

FIGS. 6-8 show example implementations of computer housings with doped layers consistent with present principles;

FIGS. 9 and 10 show an example implementation of a computer housing that has a window and substrate consistent with present principles;

FIG. 11 shows an example implementation of a computer housing that has recesses and tabs consistent with present principles;

FIGS. 12 and 13 show example implementations of a computer housing that has repeating and non-repeating patterns, respectively, consistent with present principles;

FIG. 14 shows an example implementation of computer packaging that has dots or indents consistent with present principles;

FIG. 15 is a flow chart of an example process for marking a computer product or packaging consistent with present principles;

FIG. 16 is a flow chart of an example process for authenticating a computer product consistent with present principles;

FIG. 17 is a flow chart of an example algorithm that may be executed by a server consistent with present principles; and

FIGS. 18 and 19 are example graphical user interfaces (GUIs) presentable on an electronic display to report on the status of authenticating a product consistent with present principles.

### DETAILED DESCRIPTION

Among other things, the present application discloses embodiments that utilize the fact that many products are made at least partially of hard plastic or other material that can have a textured look and feel on at least one surface for aesthetic purposes. Given this observation, the present application discloses implementations where parts of the surface texture may be encoded with a bit pattern or other data hidden by steganography and may appear purely aesthetic to the casual observer even though that is not actually the case. Furthermore, in some examples other parts of the surface may be filled with bit noise. The bit pattern itself may then be identified from among the bit noise with a micro camera or other device, and then it may be validated against a secret or preestablished bit pattern known to the source/manufacturer of the item.

The bit pattern or other steganographic data may be changed periodically to keep it fresh, and/or encoded on different parts of the device/housing for different production runs. Additionally or alternatively, the bit pattern may be serialized in that each individual product or item may have its own unique serial number indicated via the bit pattern or other steganographic data.

This non-aesthetic data may make products more difficult to fraudulently copy because fakers and imposters would not know which areas of the product's exterior were significant, what parts actually indicate data, and/or what parts are random since the steganographically hidden data may not be readily appreciated except by those who know to look for it and where.

The non-aesthetic steganographic data itself may be included on a package or computer-related component, such as the main housing of a laptop computer, desktop computer, tablet computer, smart phone, etc. However, this data may also be shown on other enclosures/components related to consumer electronics devices as well. Those other enclosures might include product packaging, housings for peripheral devices, and housings and packages for individual replacement parts that are to be integrated into or used with a larger computer (e.g., replacement parts and accessory products like off-device bits such as power supplies, power supply bricks, accessories, monitors and displays, and dongles). Those other enclosures may also be for plastic or painted parts or components, even for non-compute accessories or non-electronic replacement parts.

Prior to delving further into the details of the instant techniques, note with respect to any computer systems discussed herein that a system may include server and client components, connected over a network such that data may be exchanged between the client and server components. The client components may include one or more computing devices including televisions (e.g., smart TVs, Internet-enabled TVs), computers such as desktops, laptops and tablet computers, so-called convertible devices (e.g., having a tablet configuration and laptop configuration), and other mobile devices including smart phones. These client devices may employ, as non-limiting examples, operating systems from Apple Inc. of Cupertino Calif., Google Inc. of Mountain View, Calif., or Microsoft Corp. of Redmond, Wash. A Unix® or similar such as Linux® operating system may be used. These operating systems can execute one or more browsers such as a browser made by Microsoft or Google or Mozilla or another browser program that can access web pages and applications hosted by Internet servers over a network such as the Internet, a local intranet, or a virtual private network.

As used herein, instructions refer to computer-implemented steps for processing information in the system. Instructions can be implemented in software, firmware or hardware, or combinations thereof and include any type of programmed step undertaken by components of the system; hence, illustrative components, blocks, modules, circuits, and steps are sometimes set forth in terms of their functionality.

A processor may be any general purpose single- or multi-chip processor that can execute logic by means of various lines such as address lines, data lines, and control lines and registers and shift registers. Moreover, any logical blocks, modules, and circuits described herein can be implemented or performed with a general purpose processor, a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can also be implemented by a controller or state machine or a combination of computing devices. Thus, the methods herein may be implemented as software instructions executed by a processor, suitably configured application specific integrated circuits (ASIC) or field programmable gate array (FPGA) modules, or any other convenient manner as would be appreciated by those skilled in those art. Where employed, the software instructions may also be embodied in a non-transitory device that is being vended and/or provided that is not a transitory, propagating signal and/or a signal per se (such as a hard disk drive, CD ROM or Flash drive). The software code instructions may also be downloaded over the Internet. Accordingly, it is to be understood that although a software application for undertaking present principles may be vended with a device such as the system 100 described below, such an application may also be downloaded from a server to a device over a network such as the Internet.

Software modules and/or applications described by way of flow charts and/or user interfaces herein can include various sub-routines, procedures, etc. Without limiting the disclosure, logic stated to be executed by a particular module can be redistributed to other software modules and/or combined together in a single module and/or made available in a shareable library.

Logic when implemented in software, can be written in an appropriate language such as but not limited to C# or C++, and can be stored on or transmitted through a computer-readable storage medium (that is not a transitory, propagating signal per se) such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc.

In an example, a processor can access information over its input lines from data storage, such as the computer readable storage medium, and/or the processor can access information wirelessly from an Internet server by activating a wireless transceiver to send and receive data. Data typically is converted from analog signals to digital by circuitry between the antenna and the registers of the processor when being received and from digital to analog when being transmitted. The processor then processes the data through its shift registers to output calculated data on output lines, for presentation of the calculated data on the device.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

The term “circuit” or “circuitry” may be used in the summary, description, and/or claims. As is well known in the art, the term “circuitry” includes all levels of available integration, e.g., from discrete logic circuits to the highest level of circuit integration such as VLSI, and includes programmable logic components programmed to perform the functions of an embodiment as well as general-purpose or special-purpose processors programmed with instructions to perform those functions.

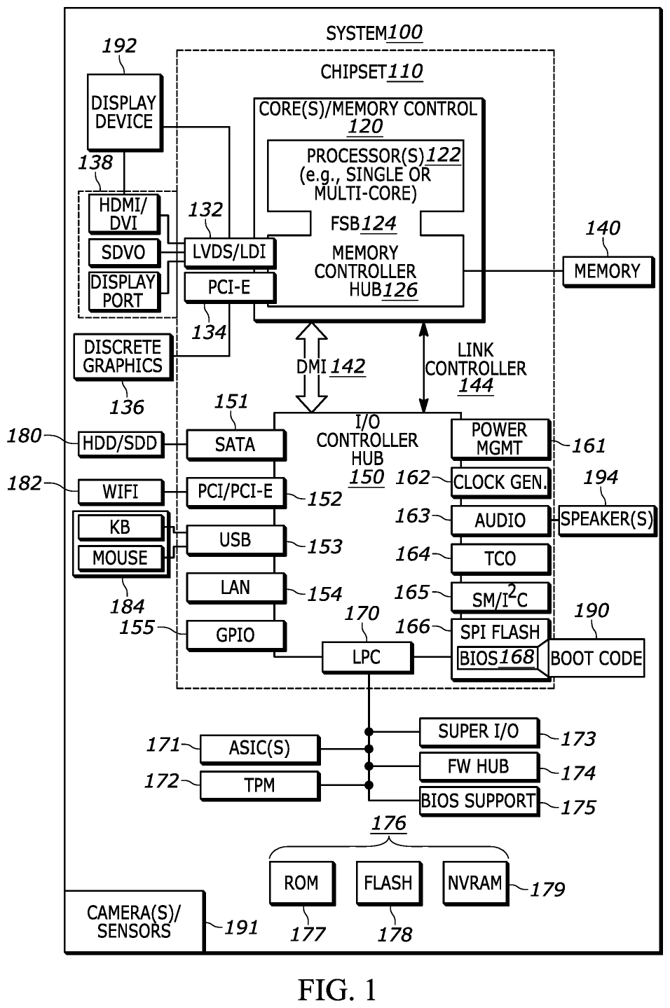

Now specifically in reference to FIG. 1, an example block diagram of an information handling system and/or computer system 100 is shown that is understood to have a housing for the components described below. The housing may be formed by one or more portions of plastic, metal, rubber, or other suitable material. Note that in some embodiments the system 100 may be a desktop computer system, such as one of the ThinkCentre® or ThinkPad® series of personal computers sold by Lenovo (US) Inc. of Morrisville, N.C., or a workstation computer, such as the ThinkStation®, which are sold by Lenovo (US) Inc. of Morrisville, N.C.; however, as apparent from the description herein, a client device, a server or other machine in accordance with present principles may include other features or only some of the features of the system 100. Also, the system 100 may be, e.g., a game console such as XBOX®, and/or the system 100 may include a mobile communication device such as a mobile telephone, notebook computer, and/or other portable computerized device.

As shown in FIG. 1, the system 100 may include a so-called chipset 110. A chipset refers to a group of integrated circuits, or chips, that are designed to work together. Chipsets are usually marketed as a single product (e.g., consider chipsets marketed under the brands INTEL®, AMD®, etc.).

In the example of FIG. 1, the chipset 110 has a particular architecture, which may vary to some extent depending on brand or manufacturer. The architecture of the chipset 110 includes a core and memory control group 120 and an I/O controller hub 150 that exchange information (e.g., data, signals, commands, etc.) via, for example, a direct management interface or direct media interface (DMI) 142 or a link controller 144. In the example of FIG. 1, the DMI 142 is a chip-to-chip interface (sometimes referred to as being a link between a “northbridge” and a “southbridge”).

The core and memory control group 120 include one or more processors 122 (e.g., single core or multi-core, etc.) and a memory controller hub 126 that exchange information via a front side bus (FSB) 124. As described herein, various components of the core and memory control group 120 may be integrated onto a single processor die, for example, to make a chip that supplants the “northbridge” style architecture.

The memory controller hub 126 interfaces with memory 140. For example, the memory controller hub 126 may provide support for DDR SDRAM memory (e.g., DDR, DDR2, DDR3, etc.). In general, the memory 140 is a type of random-access memory (RAM). It is often referred to as “system memory.”

The memory controller hub 126 can further include a low-voltage differential signaling interface (LVDS) 132. The LVDS 132 may be a so-called LVDS Display Interface (LDI) for support of a display device 192 (e.g., a CRT, a flat panel, a projector, a touch-enabled light emitting diode display or other video display, etc.). A block 138 includes some examples of technologies that may be supported via the LVDS interface 132 (e.g., serial digital video, HDMI/DVI, display port). The memory controller hub 126 also includes one or more PCI-express interfaces (PCI-E) 134, for example, for support of discrete graphics 136. Discrete graphics using a PCI-E interface has become an alternative approach to an accelerated graphics port (AGP). For example, the memory controller hub 126 may include a 16-lane (x16) PCI-E port for an external PCI-E-based graphics card (including, e.g., one of more GPUs). An example system may include AGP or PCI-E for support of graphics.

In examples in which it is used, the I/O hub controller 150 can include a variety of interfaces. The example of FIG. 1 includes a SATA interface 151, one or more PCI-E interfaces 152 (optionally one or more legacy PCI interfaces), one or more USB interfaces 153, a LAN interface 154 (more generally a network interface for communication over at least one network such as the Internet, a WAN, a LAN, etc. under direction of the processor(s) 122), a general purpose I/O interface (GPIO) 155, a low-pin count (LPC) interface 170, a power management interface 161, a clock generator interface 162, an audio interface 163 (e.g., for speakers 194 to output audio), a total cost of operation (TCO) interface 164, a system management bus interface (e.g., a multi-master serial computer bus interface) 165, and a serial peripheral flash memory/controller interface (SPI Flash) 166, which, in the example of FIG. 1, includes BIOS 168 and boot code 190. With respect to network connections, the I/O hub controller 150 may include integrated gigabit Ethernet controller lines multiplexed with a PCI-E interface port. Other network features may operate independent of a PCI-E interface.

The interfaces of the I/O hub controller 150 may provide for communication with various devices, networks, etc. For example, where used, the SATA interface 151 provides for reading, writing or reading and writing information on one or more drives 180 such as HDDs, SDDs or a combination thereof, but in any case the drives 180 are understood to be, e.g., tangible computer readable storage mediums that are not transitory, propagating signals. The I/O hub controller 150 may also include an advanced host controller interface (AHCI) to support one or more drives 180. The PCI-E interface 152 allows for wireless connections 182 to devices, networks, etc. The USB interface 153 provides for input devices 184 such as keyboards (KB), mice and various other devices (e.g., cameras, phones, storage, media players, etc.).

In the example of FIG. 1, the LPC interface 170 provides for use of one or more ASICs 171, a trusted platform module (TPM) 172, a super I/O 173, a firmware hub 174, BIOS support 175 as well as various types of memory 176 such as ROM 177, Flash 178, and non-volatile RAM (NVRAM) 179. With respect to the TPM 172, this module may be in the form of a chip that can be used to authenticate software and hardware devices. For example, a TPM may be capable of performing platform authentication and may be used to verify that a system seeking access is the expected system.

The system 100, upon power on, may be configured to execute boot code 190 for the BIOS 168, as stored within the SPI Flash 166, and thereafter processes data under the control of one or more operating systems and application software (e.g., stored in system memory 140). An operating system may be stored in any of a variety of locations and accessed, for example, according to instructions of the BIOS 168.

Additionally, the system 100 may include one or more cameras 191 or other sensors (e.g., an infrared (IR) light transceiver, a sonar transceiver, etc.). The camera(s) 191 may gather one or more images and provide them to the processor 122. The camera(s) may be a thermal imaging camera, an infrared (IR) camera, a digital camera such as a webcam, a three-dimensional (3D) camera, and/or a camera otherwise integrated into the system 100 and controllable by the processor 122 to gather pictures/images and/or video.

Additionally, though not shown for simplicity, in some embodiments the system 100 may include a gyroscope that senses and/or measures the orientation of the system 100 and provides input related thereto to the processor 122, as well as an accelerometer that senses acceleration and/or movement of the system 100 and provides input related thereto to the processor 122. Still further, the system 100 may include an audio receiver/microphone that provides input from the microphone to the processor 122 based on audio that is detected, such as via a user providing audible input to the microphone. Also, the system 100 may include a GPS transceiver that is configured to communicate with at least one satellite to receive/identify geographic position information and provide the geographic position information to the processor 122. However, it is to be understood that another suitable position receiver other than a GPS receiver may be used in accordance with present principles to determine the location of the system 100.

It is to be understood that an example client device or other machine/computer may include fewer or more features than shown on the system 100 of FIG. 1. In any case, it is to be understood at least based on the foregoing that the system 100 is configured to undertake present principles.

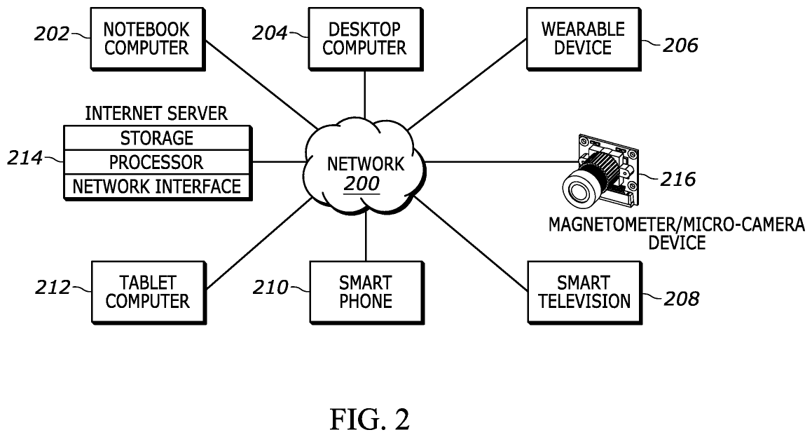

Turning now to FIG. 2, example devices are shown communicating over a network 200 such as the Internet in accordance with present principles. It is to be understood that each of the devices described in reference to FIG. 2 may include at least some of the features, components, and/or elements of the system 100 described above. Indeed, any of the devices disclosed herein may include at least some of the features, components, and/or elements of the system 100 described above.

FIG. 2 shows a notebook computer and/or convertible computer 202, a desktop computer 204, a wearable device 206 such as a smart watch, a smart television (TV) 208, a smart phone 210, a tablet computer 212, a scanning device 216, and a server 214 such as an Internet server that may provide cloud storage accessible to the devices 202-212, 216. The scanning device 216 may include one or more cameras such as micro-cameras and/or 3D cameras, magnetometers, and/or other sensors for use consistent with present principles. It is to be understood that the devices 202-216 are configured to communicate with each other over the network 200 to undertake present principles.

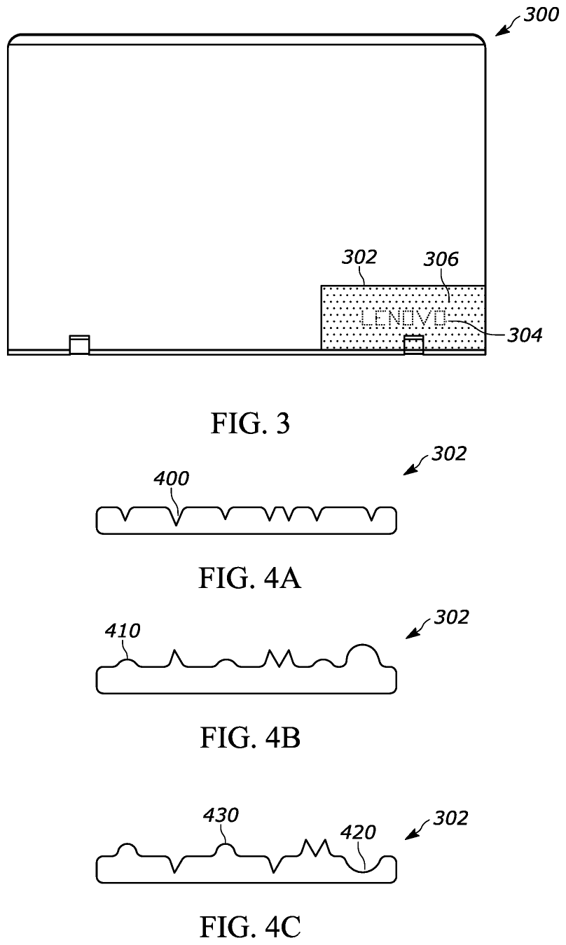

Now referring to FIG. 3, it shows an example bottom plan view of a housing 300 of a laptop computer configured consistent with present principles. As shown, at least a portion 302 of the bottom of the exterior surface of the housing 300 includes steganographic data 304 in the form of dots indicating a provider of the laptop 300, which in this case is the manufacturer of the laptop (Lenovo®).

The steganographic data 304 may be concealed or obscured from being readily-perceptible to the naked eye using a high concentration of other markings in areas proximate to and around the data 304, such as other dots 306. However, note that only a few dots 306 are shown to illustrate and that the actual steganographic data 304 is readily-perceptible in FIG. 3 to illustrate.

In some examples, the exterior surface of the bottom of the housing 300 may indicate the steganographic data 304 via a textured surface. For example, the textured surface may include peaks and/or valleys establishing the dots. The valleys may be established by grooves or indentations of varying heights into the exterior surface relative to a plane established by the exterior surface itself, and the peaks may be established by bumps of varying heights protruding from the exterior surface relative to the plane. FIG. 4A shows a side plan view of an example of the portion 302 having grooves or indentations 400 etched into the exterior surface. FIG. 4B shows a side plan view of an example of the portion 302 having bumps 410 molded onto the exterior surface. FIG. 4C shows a side plan view of an example of the portion 302 having both indentations 420 and bumps 430 located on the exterior surface.

In order for a separate electronic device (e.g., the scanning device 216 above) to detect the steganographic data 304 according to any of those varying examples, the electronic device may use, for example, a micro 3-dimensional (3D) camera, plural cameras at different locations on the electronic device, a single webcam, or even a sonar transceiver or laser rangefinder to detect whether any bump is above a first threshold height or groove below a second threshold height relative to the plane of the exterior surface. The first and second threshold heights may be the same or different from each other. The separate electronic device (or a server in communication therewith) may then select bumps above the first threshold height and grooves below the second threshold height to determine whether they establish a predefined pattern (in this case, the wording “Lenovo”).

In some examples, the electronic device (or server) may even produce a virtual image derived from the camera image(s) that maps the bumps above the first threshold height and grooves below the second threshold height with respect to each other while excluding other bumps and grooves and then execute optical character recognition (OCR) to identify the wording from the virtual image.

Assuming the predefined or expected wording can in fact be identified using the foregoing process(es), the electronic device may return that the laptop has been verified as authentic in that it is from the actual manufacturer and not a third part imposter. Thus, while the bumps and grooves of varying heights might appear random to the casual observer and might not be replicated by a provider of counterfeit goods given that fact, in fact the bumps and grooves of at least the first and second threshold heights, respectively, may actually establish the steganographic data 304 via the seemingly random but actually predetermined heights and locations of certain bumps and grooves.

Note, however, that other peaks and valleys implementations may also be used consistent with present principles. For example, rather than peaks and valleys of a threshold height being used to indicate wording of the manufacturer's name, the peaks and valleys may establish a predetermined bit pattern of zeros and ones indicating the manufacturer or certain wording (e.g., “Genuine Lenovo product”). For instance, bumps above the first threshold distance may establish zeros while grooves below the second threshold distance may establish ones, or vice versa. As another example, any bump above the first threshold distance or groove below the second threshold distance may establish ones while lesser bumps or grooves may establish zeros, or vice versa.

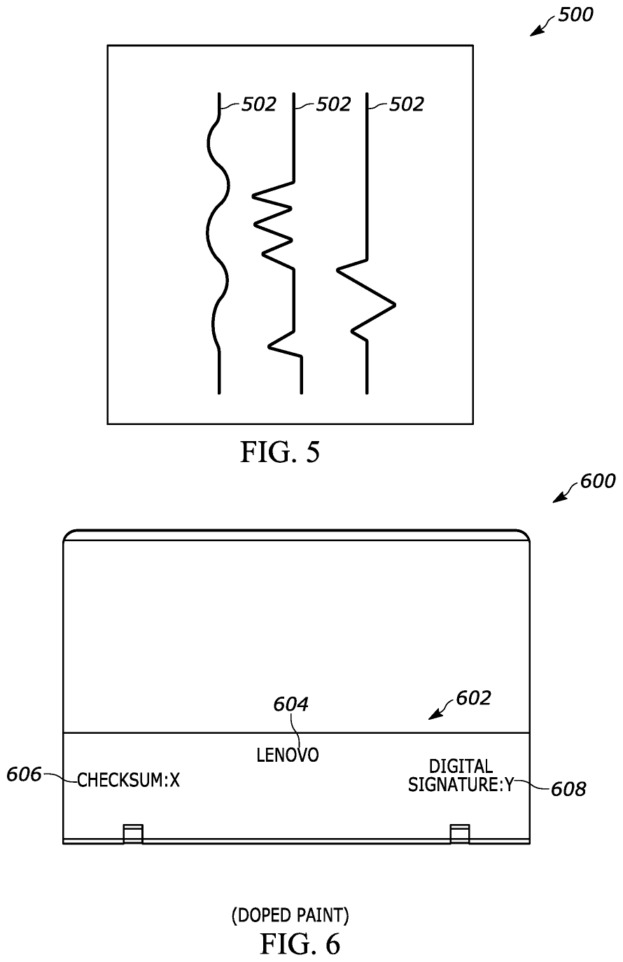

FIG. 5 shows another example consistent with present principles. Specifically, FIG. 5 shows a top plan view of the exterior surface of a lid 500 to a laptop computer that might protect a display of the laptop computer as part of a housing for the computer. As shown, plural grooves 502 of the same or different overall lengths may be etched into the lid 500. The grooves 502 might appear random to the casual observer and might not be replicated by a provider of counterfeit goods given that fact, but in fact the grooves 502 may actually establish a predetermined pattern via their seemingly random but actually predetermined oscillations of various amplitudes and shapes as shown. A camera on a separate electronic device may therefore be used to image the grooves 502 and compare the pattern established by the grooves 502 to a reference image to determine whether the pattern established by the grooves 502 matches the reference image. If the patterns in the two images match, the electronic device may return that the laptop has been verified as authentic in that it is from the manufacturer and not a third part imposter.

Furthermore, note that in addition to or in lieu of the grooves 502 establishing a predetermined graphical pattern to indicate authenticity of the laptop, the grooves 502 may indicate a predetermined bit pattern to indicate authenticity of the laptop. The bit pattern may be indicated by, for example, peaks on one side (e.g., the left side) of the longitudinal axis established by a respective groove 502 being correlated to a one, and peaks on the other side (e.g., the right side) of the longitudinal axis established by a respective groove 502 being correlated to a zero, or vice versa. A sequence of zeros and ones indicating the bit pattern may thus be established and recognized using a camera image by correlating the peaks to zeroes and ones in sequence from one predetermined end of a respective groove 502 to the other, relative to a predetermined orientation of the housing.

FIG. 6 shows yet another example consistent with present principles. Specifically, FIG. 6 shows a bottom plan view of the exterior surface of a housing 600 of a tablet computer. The exterior surface includes a portion 602 that may include a coating/layer of paint, some of which may be doped and some of which may not. Thus, doped paint 604 is shown that indicates the word “Lenovo” and may be accompanied by doped paint 606 indicating a predetermined checksum generally designated “X” for illustration as well as doped paint 608 indicating a predetermined digital signature and/or a predetermined digital signature hash generally designated “Y” for illustration. All other parts of the portion 602 may be painted with paint of the same visible light spectrum color as the doped portions, but not doped itself.

The paint 604, 606, and 608 may be doped with, for example, additional infrared (IR)-reflective paint or other material to reflect other types of light not in the light spectrum visible to human beings. However, using an IR light transceiver on a separate electronic/scanning device, IR light may be emitted from the scanning device and reflected by the paint 604, 606, and 608 back to the scanning device. The scanning device may then identify the “Lenovo” wording, checksum, and digital signature based on the reflections since paint for the other parts of the portion 602 may absorb the IR light rather than reflect it. Thus, a casual observer may not be able to perceive the “Lenovo” wording, checksum, and digital signature and those items might therefore not be replicated by a provider of counterfeit goods given that fact, but the tablet computer may still be authenticated as actually being provided by the manufacturer using the scanning device.

Also, note that in some examples, in addition to or in lieu of using the wording “Lenovo”, the checksum, and the digital signature, the doped paint may be arranged to establish a predetermined bit pattern than may also be identified as described above.

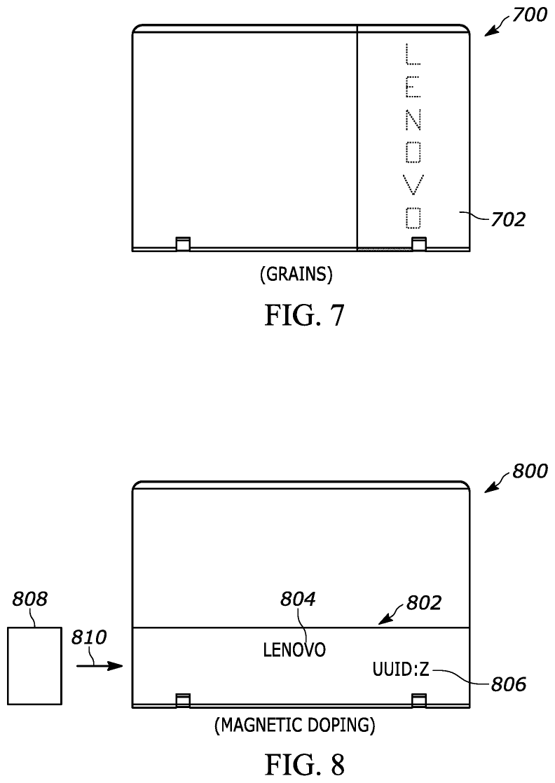

FIG. 7 shows yet another example consistent with present principles. Specifically, FIG. 7 shows a bottom plan view of the exterior surface of a housing 700 of a tablet computer. The exterior surface includes a portion 702 that may include a coating/layer of paint, some of which may be doped and some of which may not. In this case, a dopant of micro-grains or another type of kernel may be arranged to indicate the word “Lenovo” as shown. Thus, while a casual observer may not be able to perceive the “Lenovo” wording and therefore it might not be replicated by a provider of counterfeit goods given that fact, the tablet computer may still be authenticated as actually being provided by the manufacturer using a scanning device having a micro-camera and/or 3D camera capable of showing the contours of the micro-grains as arranged to indicate the wording “Lenovo”.

Also, note that in some examples, in addition to or in lieu of using the wording “Lenovo”, the micro-grains may be arranged in a predetermined bit pattern than may also be identified as described above.

FIG. 8 shows still another example consistent with present principles. Specifically, FIG. 8 shows a bottom plan view of the exterior surface of a housing 800 of a desktop computer. The exterior surface includes a portion 802 that may include a coating/layer of paint, some of which may be doped and some of which may not. Thus, doped paint 804 is shown that indicates the word “Lenovo” and may be accompanied by doped paint 806 that indicates a universally unique identifier (UUID) (and/or product serial number) that is associated with the true provider of the desktop computer and is generally designated “Z” for illustration.

In this example, the paint 804, 806 may be doped with material producing a magnetic field (and/or a material excitable under an electric field) so as to not be visible to human beings. However, using an electronic device 808 that may include a magnetometer, the electronic device may be waived over the portion 802 in the direction of the arrow 810 to detect the magnetic field created by the paint 804, 806 to map the sensed variations in the magnetic field at various locations on the portion 802 and identify the word “Lenovo” and UUID “Z”. In some examples, the mapping may even be used to generate a virtual image that indicates word “Lenovo” and UUID “Z” according to the magnetic field to thus verify the authenticity of the desktop computer from the virtual image.

Thus, a casual observer may not be able to perceive the “Lenovo” wording and UUID and therefore it might not be replicated by a provider of counterfeit goods given that fact, but the desktop computer may still be verified as actually being provided by the true manufacturer using the electronic device 808. Also note that in some examples, in addition to or in lieu of using the wording “Lenovo” and the UUID, the dopant may establish a predetermined bit pattern than may also be identified as described above.

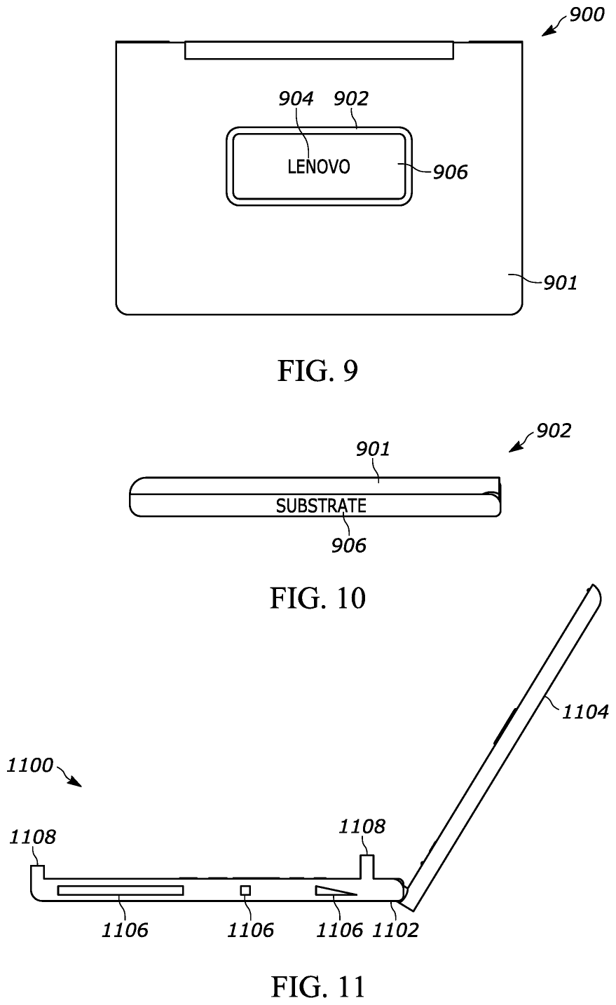

Now in cross-reference to FIGS. 9 and 10, they show yet another example consistent with present principles. FIG. 9 shows a top plan view of the exterior surface 901 of a lid 900 to a laptop computer that might protect a display of the laptop computer as part of a housing for the computer. As also shown in FIG. 9, a portion 902 of the lid 900 may include an exterior surface window 901 that may be at least semi-transparent or transparent under certain conditions in order to view steganographic data 904 indicating the word “Lenovo” as located on a substrate 906 underneath the exterior surface window 901. The substrate 906 is also shown in FIG. 10, with FIG. 10 showing a side cross-sectional view of the portion 902.

The steganographic data 904 may be identified through the window 901 when, for example, the window 901 is established by a long-wave ultraviolet (UV) light filter that appears mostly dark or even opaque to the naked eye under typical ambient lighting conditions (owing to the filter blocking other spectrums of light from passing) but still allows the long-wave ultraviolet light to pass. Thus, a blacklight/ultraviolet light may be directed to the window 901 to reveal ultraviolet light-reflective text (or other coded information) on the substrate 906 that establishes the steganographic data 904. Note that the black/UV light itself may be established by a lamp that emits long-wave ultraviolet light (e.g., UV-A), possibly along with a similar UV light filter to allow long-wave UV light from the lamp to pass out of the light while blocking other wavelengths of visible light from passing out of the light.

However, it is to be understood that other implementations of the window 901 may also be used. For example, an infrared (IR) light-transmissive window and IR-reflective text that can be scanned by a device using an IR light transceiver may be used in accordance with the description above.

As another example, the window 901 may be mostly or fully transmissive to all visible light wavelengths such as if the window 901 were composed of clear, transparent glass. Then one or more of the other embodiments discussed herein may be implemented on the substrate 906 rather than the exterior surface of the device, such as using bumps and grooves on the substrate 906 or using a dopant on the substrate 906.

Continuing now with reference to FIG. 11, it shows yet another example embodiment consistent with present principles. FIG. 11 shows a side elevational view of a portion of a side of a housing 1102 for the bottom panel of a laptop computer 1100. The computer 1100 may also have a display panel 1104 moved to an opened position as also shown in FIG. 11. The housing 1102 may include one or more indentations or recesses 1106 protruding inward from the exterior side of the housing 1102. The housing 1102 may also include one or more tabs or protrusions 1108 protruding outward away from the housing 1102. In some examples, these recesses 1106 and tabs 1108 may be small or low profile so as to not be that noticeable or bothersome to a user, and indeed they may be seemingly random or even artifacts of the manufacturing process to an unknowing observer.

However, the recesses 1106 and/or tabs 1108 may actually establish a certain predefined pattern that was predetermined by the device's true manufacturer and that may be readily identified by a person once informed of the predefined pattern. Furthermore, some of the recesses 1106 and/or tabs 1108 may in fact be random and not establish a part of the predefined pattern, and different product runs for the same device model may vary the location of such random recesses 1106 and/or tabs 1108 with respect to other recesses 11006 and/or tabs 1108 that actually establish the predetermined pattern.

Thus, owing to the seemingly random nature of the recesses/tabs as possible manufacturing artifacts that are not relevant to the operation of the laptop itself after manufacturing, these recesses/tabs may carry information authenticating that the laptop has actually been created and provided by the true manufacturer rather than by an illegitimate third part providing an unauthorized laptop that was not actually manufactured by the true manufacturer.

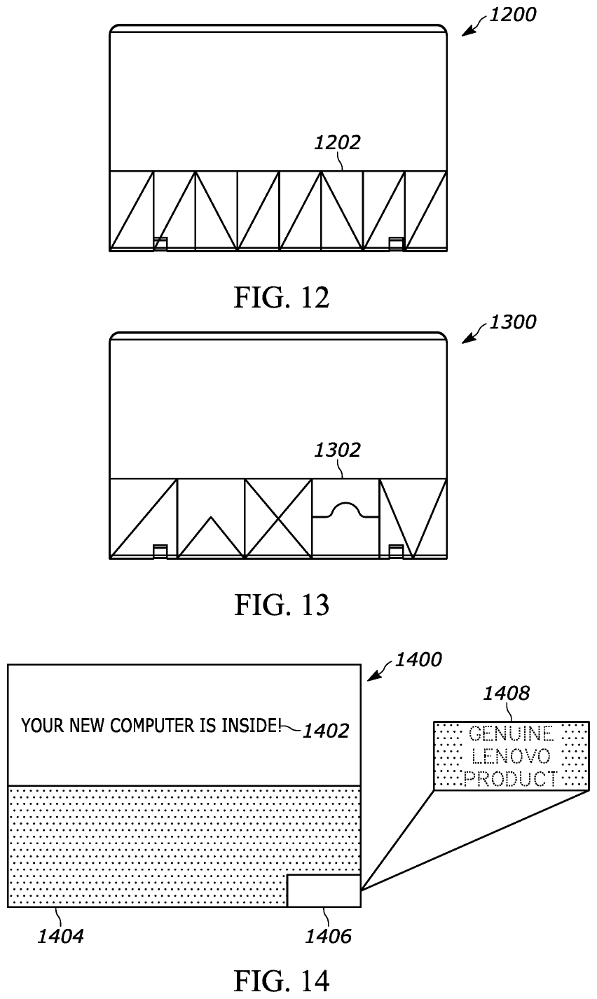

FIGS. 12 and 13 show respective bottom plan views of respective housings 1200 and 1300 of respective laptop computers that may be configured consistent with present principles. Specifically, the housing 1200 may include a printed repeating pattern 1202 while the housing 1300 may include a printed non-repeating pattern/sequence 1302. Both the patterns 1202, 1302 might appear seemingly random or purely aesthetic to the casual observer but were actually predetermined by the true manufacturer so that once recognized on the housing 1200 or 1300 after the laptop has been sold, the laptop computer may be authenticated as actually originating from the true manufacturer (as already might be explicitly indicated elsewhere on the laptop with branded logos that an imposter manufacturer would replicate).

Thus, an end user might use a software application for the manufacturer as executing on his or her smart phone along with a camera on the smart phone to image either housing 1200, 1300 and upload the image to the manufacturer's server through the application. The manufacturer may then compare either the repeating pattern 1202 or non-repeating pattern 1302 to a reference pattern or sequence to authenticate that the product as imaged is marked with the manufacturer's coded or predefined repeating/non-repeating pattern, thereby indicating the imaged product as one actually provided by the true manufacturer and not an imposter. Thus, it is to be generally understood that the steganographic data for each of the housings 1200, 1300 in this case may be indicated by the way in which the repeating 1202 pattern repeats, or the non-repeating pattern 1302 does not repeat, compared to the predefined reference pattern.

It may be appreciated that this process between the user's smart phone and the server may be done without the end user knowing precisely what the server might be doing to verify the authenticity of the laptop computer, maintaining the seemingly random or purely aesthetic pretense of the patterns 1202, 1302.

FIG. 14 shows still another example consistent with present principles. Specifically, FIG. 14 shows a top plan view of packaging 1400 such as a box for a new smart phone inside the packaging 1400. The packaging 1400 may indicate large text 1402 easily legible with the naked eye. The packaging 1400 may also include a region 1404 with a seemingly random dot pattern that may be printed on the packaging or indented into the packaging 1400. The region 1404 may include a sub-region 1406 that is illustrated in exploded view 1408. Dots in this sub-region 1406 may trace text indicating “Genuine Lenovo Product” or some other message or marking predetermined by the true manufacturer of the smart phone. This text may not be readily perceptible using the naked eye, but by knowing where to look on the packaging 1400 and using a magnifying glass to view the text in the sub-region 1406 that an imposter might not know to replicate for a fraudulent product, one might verify via the packaging 1400 that the smart phone inside is actually one from the true manufacturer.

Note that similar dot configurations may also be located on the housing of the smart phone itself, and in that vein also note that any of the other embodiments described herein may be implemented on packaging rather than a device housing consistent with present principles.

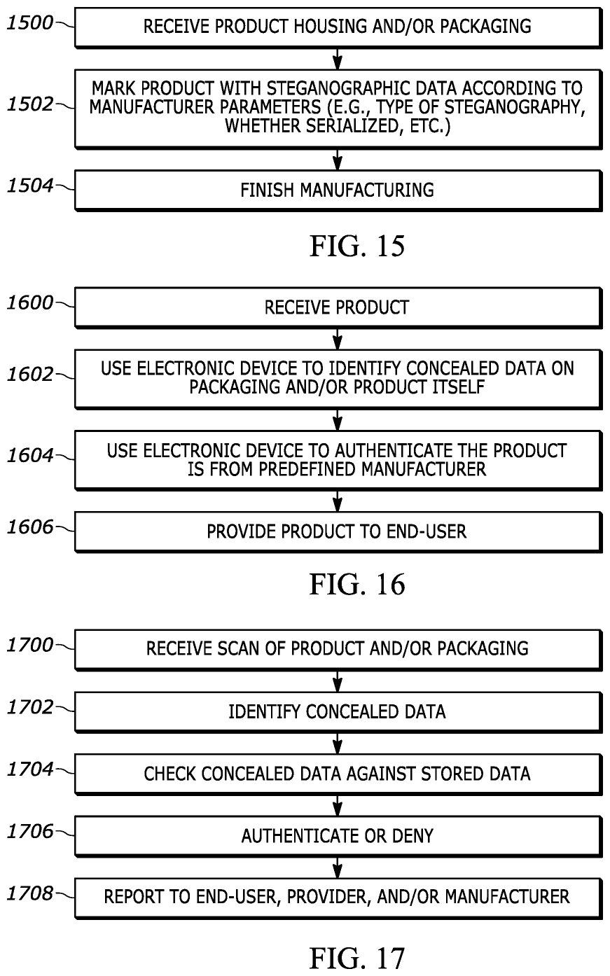

Continuing the detailed description in reference to FIG. 15, it shows a flowchart for a process of marking the packaging or housing of a product with steganographic information consistent with present principles, such as marking a housing or packaging with any of the information described above in reference to FIGS. 3-14 that indicates a true manufacturer of a computer.

At block 1500 of FIG. 15, the product housing or packaging may be received, e.g., from another part of a product assembly line during manufacturing and production. Then at block 1502 the product or packaging may be marked with steganographic data according to whatever parameters the manufacturer has predetermined for indicating the steganographic data (e.g., using a doped coating or dots indicating the name of the manufacturer along with a serial number unique to that particular respective product or packaging). Then at block 1504 manufacturing or production may be completed prior to providing the product to an end user or “middle man” entity that may ultimately provide the product to the end user so that either the middle man or end user may later authenticate/verify that the product has in fact been provided by the true manufacturer indicated on the product or packaging rather than an imposter.

The process for the middle man or end user to perform this authentication is outlined in the flow chart of FIG. 16. At block 1600 the product may be received from some one further up the distribution chain. Then at block 1602 an electronic device (or magnifying glass, black light, or another item as described herein) may be used to scan/read the product or packaging to then, at block 1604, authenticate that the steganographic/concealed information on the product in question has actually been provided by the true manufacturer. This may include checking expected data against data from the scan, including any expected data location, manufacturer indication, serial number, checksum, digital signature, digital signature hash, and/or UUID for the provider.

If the flow chart of FIG. 16 is being performed by a third party “middle man” such as an online ecommerce vendor, then step 1606 may also be performed where the product may be provided to an end-user responsive to successful electronic or other visual authentication/verification. However, also note that while step 1606 might not be performed if the rest of the logic is being performed by an end-user, steps 1602 and 1604 may still be performed by the end-user, for example, using an application on a smart phone and communication with server as described above.

Now describing FIG. 17, it shows example logic that may be executed by such a server in conjunction with a separate electronic device with which it communicates consistent with present principles. Beginning at block 1700, the sever may receive a scan of a product and/or packaging for which steganographic/concealed data is to be authenticated. The scan may be an image from a camera on the separate electronic device, input from a magnetometer, etc. Then at block 1702 the server may identify the steganographic data from the scan and, at block 1704, check or compare the identified data against stored data to then authenticate that the product is actually from the true manufacturer at block 1706 based on a match. Alternatively, at block 1706 the server may deny authentication based on returning no match at block 1704.

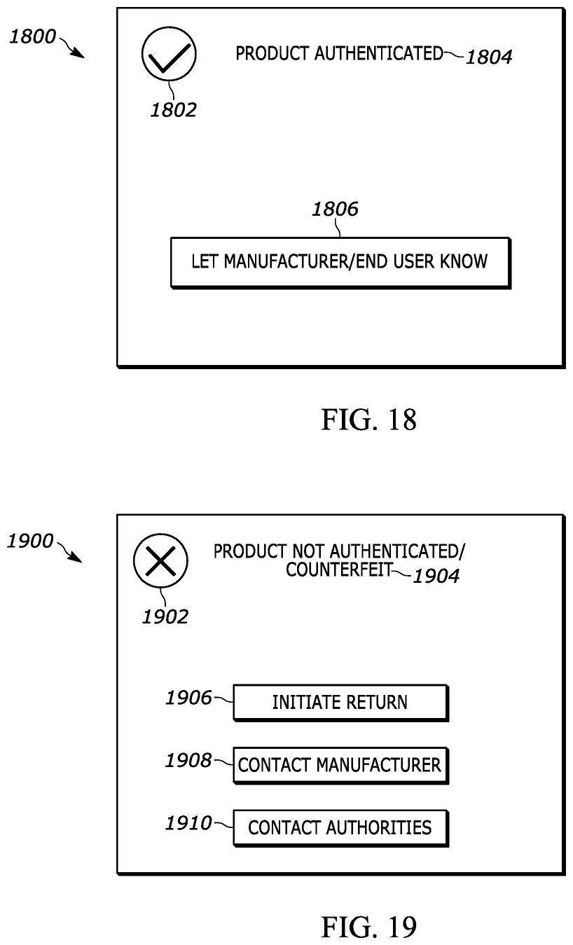

Then at block 1708 the server may report to an end user, third party middle-man provider, and/or the manufacturer itself regarding whether the product has been authenticated. For example, at block 1708 the server may electronically notify the manufacturer itself that a potentially fraudulent product has been detected so that the manufacturer can further investigate. Also at block 1708, the server may transmit a command that an audible, automated voice be output through a speaker on the separate electronic device of the end-user to report on the outcome of authentication, and/or the server may provide a command that corresponding visual information be output on an electronic display of the separate electronic device. Examples of such visual information are shown in FIGS. 18 and 19.

First describing FIG. 18, it shows an example graphical user interface (GUI) 1800 that may be presented on the display of a device such as a user's smart phone as might have been used to image product or packaging for authentication by a server consistent with present principles. The GUI 1800 may include a non-text icon 1802 such as a green circle with a green check mark inside to indicate that the product has been authenticated. The GUI 1800 may also include text 1804 indicating that the product has been authenticated as actually being provided by the true manufacturer. A selector 1806 may also be presented and selectable by the end user to initiate an electronic communication to the manufacturer to inform the manufacturer that a product has been successfully authenticated.

FIG. 19 shows another example GUI 1900 that may be presented on the display of a device such as the user's smart phone, but this time to indicate authentication failure. Thus, the GUI 1900 may include a non-text icon 1902 such as a red circle with a red “X” mark inside to indicate that the product has not been authenticated. The GUI 1900 may also include text 1904 indicating that the product has not been authenticated.

As also shown in FIG. 19, the GUI 1900 may include a selector 1906 that may be selectable to initiate a return of the product to whomever provided it (e.g., initiate a return through an online ecommerce website). The GUI 1900 may also include a selector 1908 that may be selectable to initiate an electronic communication to the manufacturer to inform the manufacturer that a product has not been successfully authenticated and might potentially be fraudulent so that the manufacturer may further investigate. Still further, the GUI 1900 may include a selector 1910 that may be selectable to initiate a telephone call or email to an appropriate law enforcement agency to inform them of a potentially fraudulent transaction that should be investigated.

Before concluding, it is to be understood that although a certain implementation might have been described above in relation to a certain location on a housing for a product or its packaging, steganographic/concealed data may be located at other various locations on the housing of the product or its packaging than the one explicitly discussed above. For example, steganographic data described in relation to a bottom surface of a computer might instead be located on a top surface or its packaging.

It is to also be understood that whilst present principals have been described with reference to some example embodiments, these are not intended to be limiting, and that various alternative arrangements may be used to implement the subject matter claimed herein. Components included in one embodiment can be used in other embodiments in any appropriate combination. For example, any of the various components described herein and/or depicted in the Figures may be combined, interchanged or excluded from other embodiments.

What is claimed is:

1. A package or computer-related component, wherein the package or computer-related component indicates steganographic data that indicates a provider of the package or computer-related component.

2. The package or computer-related component of claim 1, wherein the package or computer-related component is established by a device, the device comprising:
a housing;
at least one processor coupled to the housing;
a display accessible to the at least one processor and coupled to the housing; and
storage accessible to the at least one processor coupled to the housing.

3. The package or computer-related component of claim 2, wherein the provider of the package or computer-related component is a manufacturer of the device.

4. The package or computer-related component of claim 1, wherein an exterior surface of the package or computer-related component indicates the steganographic data via a textured surface of the exterior surface, the textured surface comprising peaks and/or valleys indicating the steganographic data.

5. The package or computer-related component of claim 4, wherein the textured surface is established by one or more of: grooves into the exterior surface, bumps protruding from the exterior surface.

6. The package or computer-related component of claim 1, wherein an exterior surface of the package or computer-related component indicates the steganographic data via a doped layer.

7. The package or computer-related component of claim 6, wherein the doped layer comprises grains in a particular arrangement that indicates the provider.

8. The package or computer-related component of claim 6, wherein the doped layer comprises magnetic dopant in a particular arrangement that indicates the provider.

9. The package or computer-related component of claim 6, wherein the doped layer comprises dopant in a particular arrangement that indicates the provider, the dopant reflecting one or more particular wavelengths of light that are not in the visible light spectrum.

10. The package or computer-related component of claim 1, wherein the package or computer-related component indicates the steganographic data on a substrate underneath an exterior surface of the package or computer-related component, at least a portion of the exterior surface being at least semi-transparent for the steganographic data to be identified through the portion of the exterior surface.

11. The package or computer-related component of claim 1, wherein the package or computer-related component indicates the steganographic data via recesses and/or tabs in the package or computer-related component created by at least one mold used to form at least a portion of the package or computer-related component.

12. The package or computer-related component of claim 1, wherein an exterior surface of the package or computer-related component comprises a repeating pattern, the steganographic data indicated by the way in which the repeating pattern repeats.

13. The package or computer-related component of claim 1, wherein an exterior surface of the package or computer-related component comprises a non-repeating pattern, the steganographic data indicated by the way in which the non-repeating pattern does not repeat.

14. The package or computer-related component of claim 1, wherein the steganographic data indicates one or more of: a checksum, a digital signature, a digital signature hash, a universally unique identifier (UUID) for the provider.

15. A method, comprising:
using an electronic device to identify concealed data on one or more of: packaging for a product, the product itself; and
using the electronic device to authenticate that the product is from a predefined manufacturer.

16. The method of claim 15, comprising:
receiving the product prior to using the electronic device to identify the concealed data and authenticate that the product is from the predefined manufacturer; and
based on identifying the concealed data and authenticating that the product is from the predefined manufacturer, providing the product to an end-user.

17. The method of claim 15, wherein the electronic device comprises a camera used to identify the concealed data.

18. An enclosure for at least one component related to a consumer electronics device, comprising:
a first portion that indicates latent or obscured data that is related to a manufacturer of the at least one component.

19. The enclosure of claim 18, wherein the enclosure is established by packaging for the at least one component.

20. The enclosure of claim 18, wherein the enclosure is established by at least a part of a housing for the at least one component.
